(19) United States
(12) Patent Application Publication
(10) Pub. No.: US 2009/0033895 A1
(43) Pub. Date: Feb. 5, 2009

(54) Lithography apparatus with flexibly supported optical system

(75) Inventors: Michael B. Binnard, Belmont, CA (US); Douglas C. Watson, Campbell, CA (US); Alton H. Phillips, East Palo Alto, CA (US); Scott Coakley, Belmont, CA (US)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/882,027

(22) Filed: Jul. 30, 2007

(51) Int. Cl. G03B 27/42

(52) U.S. Cl. 355/53

(57) ABSTRACT

A lithography apparatus includes a projection optical system that projects an image of a pattern, a first support member, a second support member that is flexibly coupled to the first support member by a first flexible coupling device such that the second support member is suspended from the first support member, and a second flexible coupling device that flexibly couples the projection optical system to the second support structure. This arrangement is capable of improving the vibration characteristics of the projection optical system.

### BACKGROUND

This invention relates to lithography apparatus and methods of performing lithographic exposure, commonly used to transfer a pattern onto a substrate in order to manufacture devices such as, for example, semiconductor devices, liquid crystal displays, etc.

Many current lithography apparatus have a large body structure that holds the projection lens, the metrology system and that supports the reticle stage and components of the illumination unit. That body typically is made very rigid and heavy in order to inhibit external forces (such as vibrations), as well as internal forces (generated due to movement of the wafer and/or mask) from causing the apparatus to vibrate. In general, a lithography apparatus having support structures with high rigidity, while providing a high apparatus performance capability, tends to make the support structure, and thus the lithography apparatus, very heavy. The high weight also results in the body having undesirably low vibration frequencies.

### SUMMARY

According to aspects of the invention, a lithography apparatus that includes a projection optical system that projects an image of a pattern includes a first support member, a second support member that is flexibly coupled to the first support member by a first flexible coupling device such that the second support member is substantially isolated from vibrations in the first support member, and a second flexible coupling device that flexibly couples the projection optical system to the second support member. This arrangement is capable of reducing the overall size and weight of the lithography apparatus.

According to preferred embodiments, the second support member is a metrology frame that also holds at least a measuring unit that measures a positional relationship between the projection optical system and a predetermined member, such as, for example, a substrate stage that holds a substrate onto which the image of the pattern is transferred by the projection optical system.

According to some embodiments, the second flexible coupling device is disposed between an upward-facing surface of the second support member and a downward-facing surface of the projection optical system such that the weight of the projection optical system is transferred to the second support member.

According to some embodiments, the second flexible coupling device inhibits vibrations from passing between the second support member and the projection optical system. The second flexible coupling device can be, for example, a passive vibration isolation system (such as, for example, rubber mounts) or an active vibration isolation system (having, for example, a voice-coil motor and damping structure).

According to some embodiments, the first flexible coupling device suspends the second support member from the first support member.

According to some embodiments, the first flexible coupling device includes a plurality of suspension members that extend between the first support member and the second support member. The suspension members are stiff in an axial direction and flexible in directions orthogonal to the axial direction. The suspension members can be, for example, wires, cables, rods or chains.

According to some embodiments, the suspension members are rotatably attached to the second support member.

According to some embodiments, the suspension members are directly attached to the first support member. According to other embodiments, the suspension members are attached to the first support member via a mounting device having a stiffness in the axial direction that is less than a stiffness of the suspension members in the axial direction. The mounting device can include, for example, a piston supported by gas so as to absorb vibrations in the axial direction. Other alternatives include springs and/or active vibration isolation devices.

### BRIEF DESCRIPTION OF THE DRAWINGS

The invention will be described in conjunction with the following drawings of exemplary embodiments in which like reference numerals designate like elements, and in which:

FIG. 1 is a schematic illustration of a lithography apparatus according to one embodiment of the invention;

FIG. 2 is a schematic representation of a mounting device for mounting a suspension member to a main support frame according to one embodiment; and

FIG. 3 is a schematic representation of a mounting device for mounting a suspension member to a main support frame according to another embodiment.

### DETAILED DESCRIPTION OF EMBODIMENTS

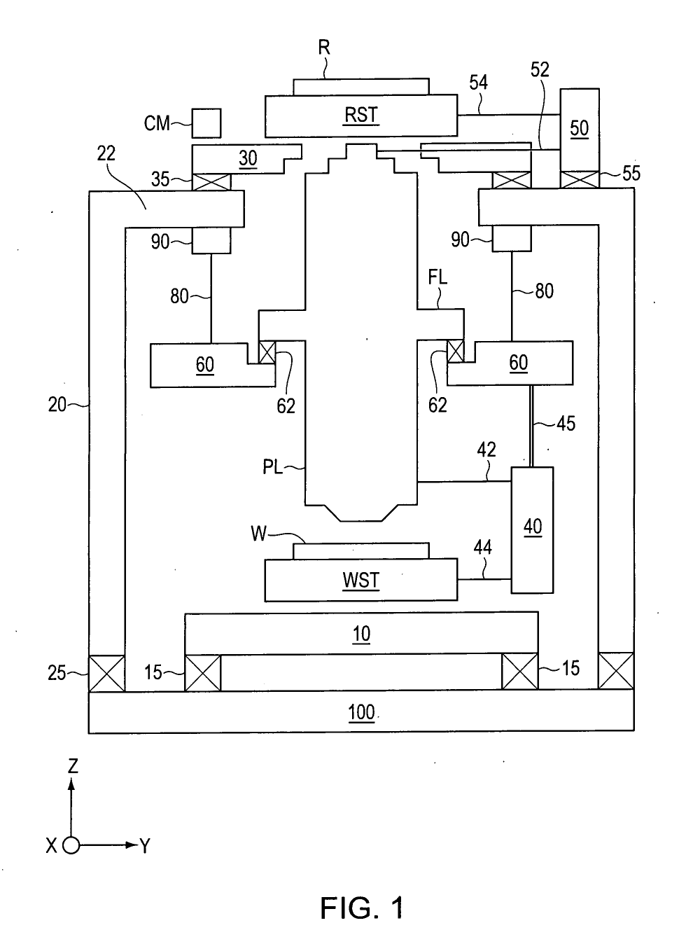

FIG. 1 is a schematic illustration of a lithography apparatus according to one embodiment of the invention. While the FIG. 1 embodiment is a scanning exposure apparatus in which a reticle R and a wafer W are moved synchronously relative to a projection optical system PL during exposure, the invention also is applicable to stationary lithography apparatus (sometimes called a “stepper”) in which the reticle R and the wafer W are maintained stationary during exposure, with the wafer being stepped from one shot area to the next between each exposure operation.

Although not shown in FIG. 1, the lithography apparatus includes a chamber in which the lithography apparatus is located, as well as a light source such as, for example, a laser light source. The light source can be a KrF excimer laser (wavelength 248 nm) or an ArF excimer laser (wavelength 193 nm), for example. The light source also could be a device that radiates an oscillating laser beam in an ultraviolet range such as an F₂ laser (wavelength 157 nm), a device that radiates a harmonic laser beam in a vacuum ultraviolet range that can be obtained by wavelength-converting a laser beam in a near infrared range supplied from a solid-state laser light source (YAG or a semiconductor laser, or the like). A mercury discharge lamp, or the like, also can be used, for example.

In addition, the lithography apparatus can be a “dry” apparatus in which a gas is disposed between the projection optical system PL and the wafer W, or it can be an immersion lithography apparatus in which a liquid such as, for example, pure water, is disposed between the projection optical system PL and the wafer W.

The lithography apparatus also includes various control systems for controlling the wafer stage WST, the reticle stage RST, the various measuring systems and the overall functioning of the apparatus.

In the FIG. 1 embodiment, the lithography apparatus includes a pedestal 100 on which the main support frame 20 and the wafer stage base 10 are mounted. It also is possible to mount the main support frame 20 and the wafer stage base 10 directly to the ground (the floor of the building in which the lithography apparatus is installed). The pedestal 100 is advantageous in that it is prefabricated with the appropriate mounting locations, piping and wiring, etc., which makes it easier to install the lithography apparatus in the factory.

The wafer stage base 10 is mounted to the pedestal 100, for example, by active or passive vibration isolation mounts 15. The isolation mounts 15 are optional; the wafer stage base can be rigidly supported by the pedestal. If the isolation mounts 15 are passive, they can be, for example, rubber mounts, gas mounts, springs, or combinations of such structures. The passive vibration isolation mounts absorb high frequency vibrations from the ground or pedestal in FIG. 1. If the isolation mounts 15 are active vibration isolation mounts, they typically include an active element such as a voice-coil motor in addition to passive structure such as, for example, gas springs, mechanical springs, rubber mounts or any combination of these, with the voice-coil motor being driven by feedback and/or feedforward control so as to maintain the wafer stage base 10 motionless. Because it is well known to mount a wafer stage base 10 with passive or active vibration isolation mounts, no further description is provided herein.

As shown in FIG. 1, the main support frame 20 also is mounted to the pedestal 100 by vibration isolation mounts 25. The vibration isolation mounts 25 also could be active or passive vibration isolation mounts. It also is possible to directly mount the main support frame 20 to the pedestal 100 (or to the ground if there is no pedestal). The isolation mounts 25 can be omitted due to the use of such mounts for mounting the projection optical system PL and the reticle stage to the main support frame 20 as described below.

In preferred embodiments, the main support frame 20 includes three upstanding pillars (only two are shown in FIG. 1) having upper ends that are attached to a support base portion 22. The pillars can be combined into one or two castings. It also is possible to have more than three pillars, such as, for example, four pillars. The pillars can be vertical, as shown in FIG. 1, or can be disposed at an angle such that the lower ends of the pillars are farther apart from each other than the upper ends of the pillars. See, for example, FIG. 2 of WO 2006/038952. The disclosure of WO 2006/038952 is incorporated herein by reference in its entirety.

A reticle stage base 30 is mounted on and supported by the main support frame 20, for example, by passive or active vibration isolation mounts 35. Mounts 35 are optional and need not always be provided. A movable reticle stage RST holding a reticle R is controlled to move in at least the Y direction on the reticle stage base 30. The reticle stage RST can have 1, 3 or 6 degrees of freedom, for example. The reticle stage RST can be the type of stage that includes a countermass CM that moves synchronously in a direction opposite to the direction in which the reticle stage RST moves so as to counteract the reaction forces generated when the reticle stage RST moves. See, for example, U.S. Pat. No. 6,246,204, the disclosure of which is incorporated herein by reference in its entirety. Of course, if the lithography apparatus is a stepper, the reticle does not need to move. An illumination optical system (not shown) also is provided and can be entirely mounted on, or have components mounted on, the main support frame 20.

A reticle stage interferometer unit 50 also is mounted on the main support frame 20. Reticle stage interferometer unit 50 also could be supported on projection lens frame member 60, to be described below. In preferred embodiments, the reticle stage interferometer 50 is mounted to the main support frame 20 via an active or a passive vibration isolation mount 55. The vibration isolation mount 55 is optional. The reticle stage interferometer 50 emits a measurement beam 52 to the projection optical system PL and emits a measurement beam 54 to the reticle stage RST so that the position of the reticle stage RST relative to the projection optical system PL can be determined. This information then is used to control the movement of the reticle stage RST. For simplicity of explanation, each measurement beam 52 and 54 is referred to in the singular; however, as is known, each beam 52, 54 can be one or more beams depending on the number of axes measured. For example, each beam can include four or more beams, and measurements can be obtained in the X, Y, Z, ⊖X, ⊖Y and ⊖Z axes. Thus, FIG. 1 is merely a simplified diagram in that the beams 52, 54 typically would be a plurality of beams emitted in different directions.

As shown in FIG. 1, a projection lens frame member 60 is suspended from the main support frame 20 by suspension members 80. While only two suspension members 80 are shown in FIG. 1, according to preferred embodiments, three suspension members 80 are provided. More than three suspension members 80 also could be provided, although three is preferred. The projection lens frame member 60 of the FIG. 1 embodiment is typically a large casting with a hole sized for the projection lens PL. The member 60 should be rigid and stable. Member 60 could be annular, circular, square, triangular or C-shaped, for example.

The suspension members 80 are stiff in the Z-direction but flexible in the X- and Y-directions, and thus function as a flexible coupling device between main support frame 20 and projection lens frame member 60. Members 80 can be a wire, rod, beam, cable or chain, for example. A lower end of each member 80 is attached to an upper surface of the projection lens frame member 60. The support members 80 should be attached to the frame member 60 in a manner that allows them to rotate freely relative to the frame member 60. For example, if the members 80 are flexible wires, cables or chains, the ends can be rigidly attached to the frame member 60 because the wire, cable or chain itself can bend or twist to act like a flexible joint. If the member 80 is a beam or a rod that is relatively stiff in bending, then flexible joints should be provided at the connection of the members 80 to the frame member 60. Each flexible joint can be, for example, a universal joint, a ball joint, a ball-in-socket, etc. A flexure also can be included with the support member 80.

The upper ends of the suspension members 80 can be attached to the main support frame 20 in a manner similar to the manner in which the lower ends of the members 80 are attached to the projection lens frame member 60. Such an attachment would make the attachment of the projection lens frame member 60 to the main support frame 20 relatively rigid in the Z-direction, but flexible in the X- and Y-directions. It is, however, preferable to attach the upper end of each suspension member 80 to the main support frame 20 with a mounting device 90 that has a stiffness in the Z-direction that is less than a stiffness of the suspension members 80 in the Z-direction. The mounting members 90 absorb vibrations of the main support frame 20 in the Z-direction so that such vibrations do not reach the projection lens frame member 60. The mounting devices 90 should be passive or active vibration isolators, although only one degree of freedom is needed. The mounting devices 90 alternatively can be provided at the lower end of the suspension members 80 (that is, between the members 80 and the projection lens frame member 60). In that alternative, the upper ends of the members 80 should be flexibly attached to the support base portion 22 of the main support frame 20 as described above (that is, using a flexible joint, although that would not be needed if the suspension members are wires, cables or chains).

As shown in FIG. 1, the projection lens PL is mounted to and supported by the suspended projection lens frame member 60 via flexible coupling devices 62. As shown in FIG. 1, the flexible coupling devices 62 are disposed between an upper surface of the frame member 60 and a lower surface of a flange FL of the projection optical system PL. Although only two flexible mounting devices 62 are shown in FIG. 1, according to preferred embodiments, there are preferably three of the coupling devices 62. The coupling devices can be passive vibration isolation members or active vibration isolation members. If passive, the isolation members 62 can include rubber or elastomer members, mechanical springs (coil, leaf, etc.), gas (or vacuum) filled chambers, or combinations thereof. If the coupling devices are active vibration isolation members, they can include voice-coil motors, attractive or repulsive magnets (permanent magnets, electromagnets or a combination) or an actively-controlled pressure chamber. The devices 62 can be a combination of passive and active isolation devices.

The coupling devices 62 are compliant (that is, not completely stiff) in at least the Z-direction (vertical direction). The coupling devices also can be compliant in the X- and Y-directions. The mounting devices thus absorb (or at least reduce the transmission of) vibrations in the direction(s) in which they are compliant.

In addition, according to some embodiments, a wafer stage interferometer 40 is rigidly mounted to the frame member 60 mounting member 45. The wafer stage interferometer 40 measures the position of the wafer stage WST relative to the projection optical system PL using beams 44 and 42, similar to beams 54 and 52 of the reticle stage interferometer 50. Beam 42 is emitted to the projection optical system PL and beam 44 is emitted to the wafer stage WST. As with the reticle stage interferometer 50, beams 42 and 44 are shown in simplified form, and actually are constituted by a plurality of beams extending in different directions depending on the axes of measurement. Other measurement devices can be rigidly mounted to the frame member 60 in addition to, or instead of, the wafer stage interferometer 40. Such other measurement devices includes, for example, devices for measuring the position of the wafer surface (this can be done, for example, with an oblique measurement beam that is reflected from the substrate surface and detected with a detector), and devices for measuring alignment of the substrate relative to the reticle, etc. The reticle stage interferometer 50 also can be mounted to the frame member 60.

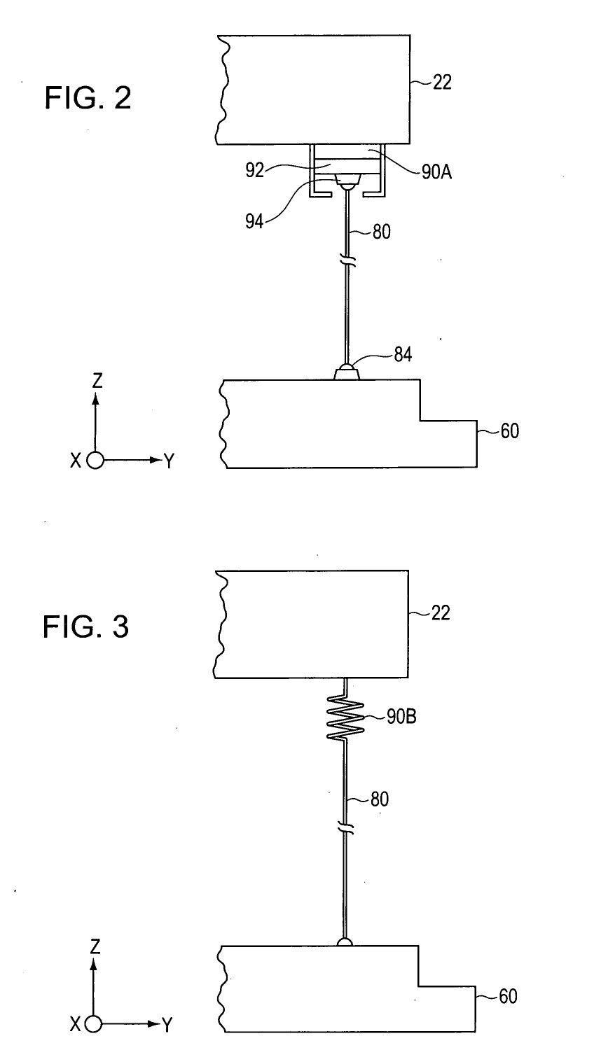

FIG. 2 shows one example of a possible structure for the mounting device 90 in FIG. 1. In this embodiment, each mounting device 90A is an isolation member having a piston 92 to which the upper end of each suspension member 80 is attached by a ball joint 94. FIG. 2 also shows a ball-in-socket joint 84 that attaches the lower end of the suspension member 80 to the frame member 60. The isolation member 90A is filled with gas at pressure below atmospheric pressure such that it exerts an upward force on suspension member 80 which supports gravity weight of frame 60 and such that it has low stiffness in the Z-direction. Therefore, the isolation member reduces or prevents Z-direction vibrations from being transmitted to the suspension members 80 (and thus to the projection lens frame member 60) from the main support frame 20. The isolation members 90A also provide the lifting force to support the weight of the projection lens frame member 60 and all components (include the projection lens PL) mounted to the frame 60. Other examples of structures that can be used as isolation members of the mounting devices 90 include: rubber or elastomer members, attractive or repulsive magnets (permanent magnet, electro-magnets or a combination), mechanical springs 90B (coil, leaf, etc.) as shown in FIG. 3, gas springs, a piston supported by pressurized gas, or any combination of passive and active isolation devices.

Placing the flexible coupling device 62 between the projection lens PL and the frame 60 is beneficial in that it can eliminate problematic vibrations that occur between the projection lens PL and the frame 60. Both the projection lens PL and the frame 60 typically are large, massive structures. To prevent distortion of either component, they must be connected by a substantially kinematic attachment. In conventional systems, this is achieved by a bolted connection at three points. Because the bolted connections are not infinitely stiff, the apparatus has a vibration mode where the projection lens PL and the frame 60 act as two masses connected by a spring (the mechanical-bolt-connection). Typically the natural frequency of this vibration is in the 50-150 Hz range. Modem lithography apparatus are particularly sensitive to vibrations in this frequency range.

Using an intentionally compliant connection between the projection lens PL and the frame 60 (that is, using the flexible coupling devices 62 between the projection lens PL and the frame 60) removes the “spring” between the two masses, and eliminates the vibration mode. In this way, stability and imaging performance of the lithography apparatus are improved.

The FIG. 1 embodiment includes many other vibration isolating elements. In the general, the more that the various modules can be isolated from each other, the more improvement can be obtained in the machine performance. There is, however, a tradeoff in that each vibration isolating device, particularly active isolating devices, adds complexity to the system. Accordingly, one or more of the vibration isolating devices of the FIG. 1 embodiment can be eliminated.

Although the FIG. 1 embodiment uses suspension members 80 to suspend frame 60, the frame 60 could be supported in other ways that do not involve suspension. For example, the frames 60 could be supported by pillars that are mounted to the ground (or a base) via vibration isolating devices (passive or active). However, combining the suspension members 80 with the flexible coupling devices 62 between the projection lens PL and the frame 60 has advantages. The pendulum effect of the members 80 provides a low lateral stiffness and therefore good isolation of the lateral vibrations. This avoids the challenges of making the flexible coupling devices 62 low-stiffness six degree-of-freedom support and vibration isolators.

The lithography apparatus of the above-mentioned embodiments can be manufactured by incorporating and optically adjusting an illumination optical system composed of a plurality of lenses and a projection system into the main body of the lithography apparatus, and installing the reticle stage and the wafer stage composed of a plurality of mechanical parts to the main body of the lithography apparatus, connecting wires and pipes, and performing overall adjustment (electrical adjustment, operation check, etc.). Furthermore, it is preferable that manufacturing of the lithography apparatus is performed in a clean room with controlled temperature and cleanliness.

Furthermore, when a semiconductor device is manufactured by using the lithography apparatus of the above-described embodiments, the semiconductor device is manufactured by a step of designing a performance capability and function of the device, a step of manufacturing a reticle based on the designing step, a step of forming a wafer from a silicon material, a step of performing alignment by the lithography apparatus of the above-mentioned embodiment and exposing a pattern of the reticle onto a wafer, a step of forming a circuit pattern such as etching or the like, a step of assembling a device (including a dicing process, a bonding process, a packaging process), a step of testing, and the like.

This invention can be applied to a liquid immersion type exposure apparatus disclosed in, for example, International Publication No. WO 99/49504. Furthermore, this invention can be applied to a lithography apparatus using extreme ultraviolet light (EUV light) having a wavelength of several nm-100 nm as an exposure beam.

Furthermore, this invention is not limited to the application for the lithography apparatus for manufacturing a semiconductor device. For example, this invention can be applied to a lithography apparatus for manufacturing various devices such as a liquid crystal display element formed on a square-shaped glass plate, or a display device such as a plasma display or the like, or an imaging element (CCD), a micro-machine, a thin-film magnetic head, a DNA chip, or the like. Furthermore, this invention can be applied to a lithography process (lithography apparatus) in which a mask (photomask, reticle, or the like) having a mask pattern of various devices is formed by using a photolithographic process.

While the invention has been described with reference to preferred embodiments thereof, which are exemplary, it is to be understood that the invention is not limited to the preferred embodiments or constructions. The invention is intended to cover various modifications and arrangements. In addition, while the various elements of the preferred embodiments are shown in various combinations and configurations, that are exemplary, other combinations and configurations, including more, less or only a single element, are also within the spirit and scope of the invention.

What is claimed is:

1. A lithography apparatus comprising:
a projection optical system that projects an image of a pattern;
a first support member;
a second support member coupled to the first support member and supporting at least one metrology component; and
a flexible coupling device that flexibly couples the projection optical system to the second support member.

2. The lithography apparatus according to claim 1, wherein the flexible coupling device is disposed between the second support member and the projection optical system such that the weight of the projection optical system is transferred to the second support member.

3. The lithography apparatus according to claim 2, wherein the flexible coupling device inhibits vibrations from passing between the second support member and the projection optical system.

4. The lithography apparatus according to claim 2, wherein the flexible coupling device is a passive vibration isolation system.

5. The lithography apparatus according to claim 2, wherein the flexible coupling device is an active vibration isolation system.

6. The lithography apparatus according to claim 1, further comprising a support member flexible coupling device that flexibly couples the second support member to the first support member.

7. The lithography apparatus according to claim 6, wherein the support member flexible coupling device suspends the second support member from the first support member.

8. The lithography apparatus according to claim 7, wherein the support member flexible coupling device includes a plurality of suspension members that extend between the first support member and the second support member.

9. The lithography apparatus according to claim 8, wherein each of the suspension members is stiff in an axial direction and flexible in directions orthogonal to the axial direction.

10. The lithography apparatus according to claim 8, wherein each of the suspension members is a wire.

11. The lithography apparatus according to claim 10, wherein each of the wires is rotatably attached to the second support member.

12. The lithography apparatus according to claim 8, wherein each of the suspension members is a rod.

13. The lithography apparatus according to claim 12, wherein each of the rods is rotatably attached to the second support member.

14. The lithography apparatus according to claim 8, wherein each of the suspension members is a chain.

15. The lithography apparatus according to claim 14, wherein each of the chains is rotatably attached to the second support member.

16. The lithography apparatus according to claim 8, wherein each of the suspension members is directly attached to the first support member.

17. The lithography apparatus according to claim 8, further comprising a mounting device between each of the suspension members and the first support member, the mounting device having a stiffness in the axial direction that is less stiff than a stiffness of the suspension members in the axial direction.

18. The lithography apparatus according to claim 17, wherein the mounting device includes a piston supported by gas so as to absorb vibrations in the axial direction.

19. The lithography apparatus according to claim 1, wherein the at least one metrology component includes a measuring unit attached to the second support member.

20. The lithography apparatus according to claim 19, wherein the measuring unit measures a positional relationship between the projection optical system and a predetermined member.

21. The lithography apparatus according to claim 20, further comprising a stage for supporting an object, and wherein the measuring unit measures a positional relationship between the projection optical system and the stage.

22. The lithography apparatus according to claim 21, wherein the stage is a substrate stage.

23. The lithography apparatus according to claim 21, wherein the stage is a reticle stage.

24. The lithography apparatus according to claim 1, wherein the first support member is a frame.

25. The lithography apparatus according to claim 24, further comprising a reticle stage supported on the frame.

26. A lithography apparatus comprising:
a projection optical system that projects an image of a pattern;
a first support member;
a metrology frame to which is mounted a measuring unit that measures a positional relationship between the projection optical system and a predetermined member;
a first flexible coupling device that flexibly couples the metrology frame to the first support member; and
a second flexible coupling device that flexibly couples the projection optical system to the metrology frame.

27. The lithography apparatus according to claim 26, wherein the first flexible coupling device suspends the metrology frame from the first support member.

28. The lithography apparatus according to claim 26, wherein the second flexible coupling device is disposed between an upward-facing surface of the metrology frame and a downward-facing surface of the projection optical system such that the weight of the projection optical system is transferred to the metrology frame.

29. The lithography apparatus according to claim 28, wherein the second flexible coupling device inhibits vibrations from passing between the metrology frame and the projection optical system.

30. The lithography apparatus according to claim 28, wherein the second flexible coupling device is a passive vibration isolation system.

31. The lithography apparatus according to claim 28, wherein the second flexible coupling device is an active vibration isolation system.

32. The lithography apparatus according to claim 26, wherein the first flexible coupling device is stiff in an axial direction and less stiff in directions orthogonal to the axial direction.

33. The lithography apparatus according to claim 32, wherein the first flexible coupling device includes a plurality of suspension members that extend between the first support member and the metrology frame.

34. The lithography apparatus according to claim 33, wherein each of the suspension members is stiff in an axial direction and flexible in directions orthogonal to the axial direction.

35. The lithography apparatus according to claim 33, wherein each of the suspension members is a wire.

36. The lithography apparatus according to claim 35, wherein each of the wires is rotatably attached to the second support member.

37. The lithography apparatus according to claim 33, wherein each of the suspension members is a rod.

38. The lithography apparatus according to claim 37, wherein each of the rods is rotatably attached to the second support member.

39. The lithography apparatus according to claim 33, wherein each of the suspension members is a chain.

40. The lithography apparatus according to claim 39, wherein each of the chains is rotatably attached to the second support member.

41. The lithography apparatus according to claim 33, wherein each of the suspension members is directly attached to the first support member.

42. The lithography apparatus according to claim 33, further comprising a mounting device between each of the suspension members and the first support member, the mounting device having a stiffness in the axial direction that is less stiff than a stiffness of the suspension members in the axial direction.

43. The lithography apparatus according to claim 42, wherein the mounting device includes a piston supported by gas so as to absorb vibrations in the axial direction.

44. The lithography apparatus according to claim 26, further comprising a stage for supporting an object, and wherein the measuring unit measures a positional relationship between the projection optical system and the stage.

45. The lithography apparatus according to claim 44, wherein the stage is a substrate stage.

46. The lithography apparatus according to claim 44, wherein the stage is a reticle stage.

47. The lithography apparatus according to claim 26, wherein the first support member is a frame.

48. The lithography apparatus according to claim 47, further comprising a reticle stage supported on the frame.

49. A lithography apparatus comprising:
a projection optical system that projects an image of a pattern;
a first support member;
a second support member;
a first flexible coupling having at least three flexible suspension members that flexibly couple the second support member to the first support member such that the second support member is suspended from the first support member; and
a second flexible coupling having at least three vibration isolation mounts disposed between the projection optical system and the second support member to flexibly couple the projection optical system to the second support member.

50. The lithography apparatus according to claim 49, wherein the at least three vibration isolation mounts of the second flexible coupling device are passive vibration isolation mounts.

51. The lithography apparatus according to claim 49, wherein the at least three vibration isolation mounts of the second flexible coupling device are active vibration isolation mounts.

52. The lithography apparatus according to claim 49, wherein each of the suspension members is stiff in an axial direction and flexible in directions orthogonal to the axial direction.

53. The lithography apparatus according to claim 52, wherein each of the suspension members is a wire.

54. The lithography apparatus according to claim 53, wherein each of the wires is rotatably attached to the second support member.

55. The lithography apparatus according to claim 49, wherein each of the suspension members is a rod.

56. The lithography apparatus according to claim 55, wherein each of the rods is rotatably attached to the second support member.

57. The lithography apparatus according to claim 49, wherein each of the suspension members is a chain.

58. The lithography apparatus according to claim 57, wherein each of the chains is rotatably attached to the second support member.

59. The lithography apparatus according to claim 49, further comprising a mounting device between each of the suspension members and the first support member, the mounting device having a stiffness in the axial direction that is less stiff than a stiffness of the suspension members in the axial direction.

60. The lithography apparatus according to claim 59, wherein each of the mounting devices is a vibration isolation member.

61. The lithography apparatus according to claim 60, wherein each of the mounting devices is a passive vibration isolation member.

62. The lithography apparatus according to claim 60, wherein each of the mounting devices is an active vibration isolation member.

63. The lithography apparatus according to claim 49, further comprising a measuring unit attached to the second support member.

64. The lithography apparatus according to claim 63, wherein the measuring unit measures a positional relationship between the projection optical system and a predetermined member.

65. The lithography apparatus according to claim 64, further comprising a stage for supporting an object, and wherein the measuring unit measures a positional relationship between the projection optical system and the stage.

66. The lithography apparatus according to claim 65, wherein the stage is a substrate stage.

67. The lithography apparatus according to claim 65, wherein the stage is a reticle stage.
